(19) United States
(12) Patent Application Publication
(10) Pub. No.: US 2014/0175974 A1
(43) Pub. Date: Jun. 26, 2014

(54) GAS DISCHARGE LAMP WITH GETTER AND METHOD FOR PRODUCING A GAS DISCHARGE LAMP

(71) Applicants: Stephan Appel, Augsburg (DE); Renate Hirrle, Augsburg (DE); Armin Konrad, Grossaitingen (DE); Matthias Schiplage, Gersthofen (DE); Markus Schoenheits, Augsburg (DE); Christina Wille, Friedberg (DE)

(72) Inventors: Stephan Appel, Augsburg (DE); Renate Hirrle, Augsburg (DE); Armin Konrad, Grossaitingen (DE); Matthias Schiplage, Gersthofen (DE); Markus Schoenheits, Augsburg (DE); Christina Wille, Friedberg (DE)

(73) Assignee: OSRAM GMBH, Muenchen (DE)

(21) Appl. No.: 14/234,656

(22) PCT Filed: Jun. 13, 2012
(86) PCT No.: PCT/EP2012/061194

§ 371 Date: Jan. 24, 2014

(30) Foreign Application Priority Data
Jul. 26, 2011 (DE) 10 2011 079 776.9

(51) Int. Cl. H01J 61/26; H01J 9/26

(52) U.S. Cl. CPC H01J 61/26; H01J 9/266
USPC 313/561; 313/562; 445/55

(57) ABSTRACT

A gas discharge lamp may include: a discharge vessel; getter material in the discharge vessel, wherein the getter material has been introduced into the discharge vessel in anhydrous form. A method for producing the gas discharge lamp may include: introducing getter material into the discharge vessel of the gas discharge lamp, wherein the getter material is introduced into the discharge vessel in anhydrous form.

### RELATED APPLICATIONS

The present application is a national stage entry according to 35 U.S.C. §371 of PCT application No.: PCT/EP2012/061194 filed on Jun. 13, 2012, which claims priority from German application No.: 10 2011 079 776.9 filed on Jul. 26, 2011, and is incorporated herein by reference in its entirety.

### TECHNICAL FIELD

Embodiments of the disclosure relate to a gas discharge lamp and a method for producing a gas discharge lamp.

### BACKGROUND

Gas discharge lamps such as, for example, low-pressure gas discharge lamps are in widespread use nowadays. A low-pressure gas discharge lamp has a discharge vessel which is coated on the inner side with a fluorescent phosphor. The gas fill used is at present generally mercury (Hg) vapor for the emission of ultraviolet (UV) radiation and in addition usually argon (Ar) as background gas. The mercury vapor is in this case produced by virtue of the fact that mercury is introduced into the lamp in liquid form, in the form of mercury alloys or in the form of other mercury mixtures, and some of the mercury evaporates during operation of the lamp and a typical mercury vapor pressure is set during operation. The mercury atoms of the mercury vapor are excited during a discharge process to emit UV radiation, which is converted by the phosphor coating into visible light.

One problem with the production of such gas discharge lamps consists in the fact that impurities in the lamp atmosphere, in particular water and carbon dioxide, necessitate the introduction of a relatively high quantity of mercury into the lamp since some of the mercury reacts with the impurities and therefore is no longer available for the discharge process which is necessary for the light generation.

For example, WO 2004/055860 A1 discloses introducing magnesium oxide or alkali earth metal pyroborates which are intended to bind the water in the form of a coating or as constituents in a coating into the lamp. One disadvantage of this procedure consists in that the desiccation effect (=getter effect) is relatively weak in comparison with other desiccants (=getter materials). One reason for this is that the desiccant is in the form of a coating which only achieves its effectiveness (so-called activation) by drying and heating. This activation is insufficient for achieving a good drying effect since, firstly, the temperatures during the baking process are too low and, secondly, after the baking process, impurities can be taken up by the coating from the ambient air, with the result that this coating is already at least partially saturated with impurities from the ambient air during production of the lamp and therefore during later operation of the lamp there is no longer the full desiccation capacity available for impurities contained in the lamp atmosphere.

One problem on which the disclosure is based can be considered to be that of providing a gas discharge lamp and a production method for a gas discharge lamp in which the concentration of impurities in the lamp atmosphere is reduced in comparison with conventional lamps.

### SUMMARY

Various embodiments provide a gas discharge lamp and a method for producing a gas discharge lamp.

The embodiments described herein in connection with the gas discharge lamp apply accordingly also to the method, and vice versa. In addition, it should be noted that the embodiments and configurations described herein are not mutually exclusive, but that one or more of the embodiments or configurations described herein can each be combined with one or more of the other of the embodiments or configurations described herein.

In accordance with one embodiment, a gas discharge lamp is provided. The gas discharge lamp has a discharge vessel. The gas discharge lamp also has getter material (in other words a material with the function of a getter) in the discharge vessel, wherein the getter material has been introduced into the discharge vessel in anhydrous form.

In accordance with a further embodiment, a method for producing a gas discharge lamp is provided, which method includes introducing getter material into a discharge vessel of the gas discharge lamp, wherein the getter material is introduced into the discharge vessel in anhydrous form.

A “getter material” or “getter” can in the context of this application be understood to mean, for example, a chemically reactive material or chemically reactive substance which has the property that certain molecules (for example carbon dioxide, carbon monoxide or water molecules) form a direct chemical bond with the atoms of the getter material at the surface of the getter or the molecules are held by sorption. In this case, the molecules can be subject to physisorption or chemisorption. In this way, the molecules can be “captured” by means of the getter, which is also referred to as “gettering”.

A “desiccant” can in the context of this application be understood to mean, for example, a material or substance which is used to extract water. The water can be chemically bonded, for example, or the desiccation can be performed by adsorption. In particular, the term “desiccant” used herein can refer to, for example, a getter material which is suitable for capturing or gettering water or water molecules from an ambient atmosphere.

In the context of this application, the expression “anhydrous” or “in anhydrous form” can be understood to mean that the composition of a material, in particular the composition of the getter materials described herein (for example desiccant), corresponds to its chemical formula, and the number of superficially absorbed water molecules is equal to zero or minimal, wherein “minimal” corresponds to the water concentration after complete desiccation or activation.

The gas discharge lamp can be any desired gas discharge lamp, for example any desired low-pressure gas discharge lamp.

The gas discharge lamp and/or the discharge vessel of the gas discharge lamp can have any desired form. For example, the lamp can be in the form of a tubular lamp and the discharge vessel can be in the form of a tubular lamp bulb (for example glass bulb), but alternatively any other desired types and/or forms of gas discharge lamps or discharge vessels (for example lamp bulbs) can be selected.

In accordance with various embodiments, the getter material can include a first getter material (for example a first desiccant) and at least one further getter material (for example desiccant). The at least one further getter material can be, for example, a getter material that is different than the first getter material.

In accordance with various embodiments, the introduction of the getter material(s) (for example the desiccant(s)) into the discharge vessel can be performed by introducing at least one receiving container which contains the getter material(s) into the discharge vessel.

The at least one receiving container can, in accordance with various embodiments, be designed in such a way that it is closed when it is introduced into the discharge vessel (in other words the getter material(s) contained therein is/are enclosed and do/does not come into contact with the ambient atmosphere (in particular the lamp atmosphere)) and can be opened once it has been introduced into the discharge vessel (for example after evacuation and/or sealing of the discharge vessel), with the result that the getter material(s) contained in the receiving container come into contact with the lamp atmosphere. Owing to the fact that the getter material is introduced into the discharge vessel of the lamp in a closed receiving container and the receiving container is only opened after the introduction (for example after evacuation and/or sealing of the discharge vessel), it is possible to avoid a situation in which, for example, the getter material contained in the receiving container comes into contact with the lamp atmosphere and impurities contained therein prematurely (for example prior to evacuation and/or sealing of the discharge vessel) and is possibly saturated partially by the impurities.

During operation of a gas discharge lamp such as, for example, a low-pressure gas discharge lamp (for example a low-pressure gas discharge lamp based on a mercury discharge), ultraviolet (UV) radiation is produced. This UV radiation can result in the getter material (for example desiccant) or the impurities bonded in the getter material (for example desiccant) (for example water bonded in the desiccant) being released by photodissociation. Some of the bonded impurities (for example the bonded water) could thus pass back into the discharge atmosphere during operation of the lamp.

In this context, a further effect of the introduction of the getter material by means of a receiving container can be considered to be that of it being possible for the getter material to be present in the receiving container in a manner in which it is protected from the UV radiation produced during operation of the lamp, for example by virtue of the fact that the material of the receiving container is selected in such a way that it wholly or partially absorbs the UV radiation.

In accordance with various embodiments, the at least one receiving container may include an ampoule or can be in the form of an ampoule.

The ampoule can be, for example, a glass ampoule (for example a silica glass ampoule (also referred to as quartz glass ampoule) or a glass ampoule consisting of a glass which is impermeable to UV radiation) or a ceramic ampoule. Alternatively, the ampoule may include or consist of other suitable materials.

In other words, the introduction into the lamp in the form of one (or more) ampoule (for example glass ampoule or ceramic ampoule) filled with getter material (for example desiccant). The ampoule can be fastened, for example, on one or more electrode frames of the lamp (in the case of a lamp with electrodes) or can be fastened (for example fused) on the inner side of the discharge vessel (for example in the case of an electrode-less lamp, but also in the case of a lamp with electrodes). After sealing of the lamp, the ampoule can be opened by means of a suitable technique. For example, the ampoule can be opened by heating, for example by virtue of a metal wire connected to the ampoule (for example wound around the ampoule) being heated by means of an electric current (for example direct current) or inductively and thus a stress being generated in the material of the ampoule (for example glass) (thermally induced stress), which results in the ampoule opening (clearly breaking open). Alternatively, the ampoule can be opened optically, for example by means of a laser beam.

Once the ampoule has been opened, the getter material (for example desiccant) contained in the ampoule comes into contact with the lamp atmosphere and extracts the impurities to be removed (for example water traces) from this lamp atmosphere.

In accordance with various embodiments, the ampoule may include or consist of a material which is impermeable or virtually impermeable to UV radiation. For example, an ampoule which includes or consists of a UV-absorbing glass can be used. In this way, the effect of the UV radiation produced during the gas discharge (for example mercury discharge) on the ampoule contents (i.e. the getter material(s) contained in the ampoule) can be reduced.

In order to prevent the getter material (for example desiccant) from falling out of the ampoule (in general out of the receiving container), the ampoule (generally the receiving container) in accordance with various embodiments may include a retaining device, which is designed in such a way that the getter material (for example desiccant) is retained in the ampoule (generally in the receiving container) and cannot emerge from the ampoule (generally from the receiving container). The retaining device should in this case be designed in such a way as to ensure that the getter material (for example desiccant) comes into contact with the lamp atmosphere once the ampoule (generally the receiving container) has been opened.

In accordance with one embodiment, the retaining device of the ampoule can be, for example, a perforated partition wall. The perforated partition wall can consist, for example, of glass (for example in the case of a glass ampoule) or of ceramic (for example in the case of a ceramic ampoule). In accordance with other embodiments, the retaining device can be an open-pore sintered glass plate or an open-pore foam glass plate. The perforation of the perforated partition wall or the pore size of the open-pore foam glass plate or sintered glass plate can each be selected such that, firstly, the getter material (for example desiccant) cannot emerge out of the ampoule through the perforation or pores (since the perforation or pores are clearly too small or narrow for this) and, secondly, the lamp atmosphere and impurities contained in the lamp atmosphere, such as, for example, water, come into contact with the getter material (for example desiccant) (since the perforation or pores are clearly large enough for impurities (for example water molecules) to pass through).

In accordance with a further embodiment, the receiving container may include an ampoule (for example a glass ampoule or a ceramic ampoule) and a crucible (for example metal crucible) located in the ampoule. In other words, in accordance with this embodiment, the introduction of the getter material(s) can be performed in the form of an ampoule, in which a crucible (for example metal crucible) is located which contains the getter material(s). A crucible in the form of a metal crucible may include or consist of, for example, at least one of the following metals or an alloy of at least two of the following metals: molybdenum, tungsten, iron, nickel, cobalt, manganese, chromium. The crucible (for example metal crucible) can be used to protect the getter material contained therein from UV radiation, with the result that the occurrence of photo dissociation and therefore the rerelease of bonded impurities (for example water) can be avoided.

In accordance with one embodiment, the crucible (for example metal crucible) can have one or more openings, with the result that the getter material(s) (for example desiccant) can come into contact with the lamp atmosphere once the ampoule has been opened without falling out of the ampoule. In other words, the size of the opening(s) can be selected such that, firstly, the getter material cannot pass through the openings in the crucible, but secondly, the lamp atmosphere and impurities contained therein (for example water, carbon dioxide and/or other gas molecules) can come into contact with the getter material located in the crucible through the openings.

In accordance with an alternative embodiment, the receiving container can be in the form of a metal capsule. In other words, in accordance with this embodiment, a metal capsule which contains the getter material(s) can be introduced into the discharge vessel.

In accordance with one embodiment, the receiving container (for example an ampoule, an ampoule with a crucible (for example metal crucible) located therein or a metal capsule) can be designed in such a way that it can receive a plurality of (for example two, three, four, etc.) different getter materials with, for example, a different getter effect (for example a getter material with a getter effect for water, a getter material with a getter effect for carbon dioxide (CO₂), etc.), wherein at least those getter materials which would react chemically with one another in an undesirable manner (for example exothermically) on mutual contact are separated or isolated from one another. This can be achieved, for example, by virtue of the fact that the receiving container has two or more chambers (also referred to as sections or compartments) and at least those getter materials which would react chemically with one another on mutual contact are each accommodated separately from one another in individual chambers. In other words, for example, a first getter material can be contained in a first chamber, and a second getter material which would react chemically with the first getter material in an undesirable manner on contact with the first getter material can be contained in a second chamber, in such a way that the two getter materials cannot come into contact with one another but can each come into contact with the atmosphere (once the receiving container has been opened). This principle can be extended correspondingly to three or more getter materials, of which one or all react with one another in an undesirable manner. As an alternative or in addition, getter materials which do not react with one another chemically can also be accommodated in separate chambers. In accordance with one configuration, a corresponding retaining device (for example perforated partition wall, open-pore sintered glass plate or foam glass plate) can be provided, for example, for each chamber, which retaining device serves the purpose of retaining the getter material contained in the respective chamber within the chamber, wherein the retaining device is designed in such a way that the getter material contained in the chamber can come into contact with the ambient atmosphere (for example lamp atmosphere) once the receiving container has been opened.

In accordance with various embodiments, a plurality of (for example two, three, four, etc.) receiving containers which each contain one or more (for example different) getter materials can be introduced into the discharge vessel. Each of the receiving containers can in this case be designed in accordance with one or more of the embodiments described herein.

For example, in accordance with one embodiment, a first receiving container which contains a first getter material and a second receiving container which contains a second getter material (which would react, for example, with the first getter material on contact) are introduced into the discharge vessel. The first and/or second discharge vessel can also each contain a plurality of getter materials, in accordance with a further embodiment.

In accordance with various embodiments, it is possible to fasten (in other words fix) the receiving container(s) (for example the ampoule(s), for example glass ampoule(s)) on the discharge vessel (for example lamp bulb) already prior to the coating process (phosphor coating process). In the case of a glass ampoule, this can be performed, for example, by means of heating to above the transformation temperature and directly adhesively bonding the glass surfaces of the discharge vessel (for example the lamp bulb) and the ampoule to one another or else with the aid of a glass solder which acts as bonding agent.

In accordance with a further embodiment, the getter material(s) can be introduced directly (in other words not contained in a receiving container) into the discharge vessel of the lamp. In other words, the getter material can in this case be freely movable within the discharge vessel once it has been introduced into the discharge vessel and can come into contact, for example, with the phosphor coating on the inner side of the discharge vessel.

In accordance with a further embodiment, it is possible for some of the getter material to be introduced directly and for another portion of the getter material to be introduced into the discharge vessel by means of one or more receiving containers. In this case, the directly introduced getter material and the getter material introduced by means of the receiving container(s) may include or be the same getter materials or different getter materials.

In accordance with various embodiments, the getter material (for example desiccant) can be introduced into the discharge vessel in the form of regular (in other words regularly shaped) bodies, for example in the form of pressed or sintered bodies or in the form of melt reguli. The getter material (for example desiccant) can be introduced into the discharge vessel of the lamp, for example, in the form of pressed or sintered bodies or in the form of melt reguli having a size (for example diameter) in the range of from approximately 1 mm to approximately 2 mm. The introduction of the getter material (for example desiccant) into the discharge vessel can in this case be performed, for example, prior to a pumping process, for example through an exhaust pipe or exhaust tube. The getter material (for example desiccant) can have a small surface-to-volume ratio. Owing to the particle size, it is possible for the getter material (for example desiccant) to not be distributed homogeneously over the coating of the discharge vessel. The individual particles (for example approximately 1 mm to 2 mm in size) can be freely movable within the discharge vessel.

One aspect of the disclosure can be considered that of introducing one or more getter materials (for example desiccants) into the lamp or the discharge vessel (for example lamp bulb) which have a greater getter effect (for example desiccation effect), for example in particular in comparison with the coating with magnesium oxide or alkali earth pyroborates, as described in WO 2004/055860 A1.

A further aspect of the disclosure can be considered that of improving the gas purity of a lamp by virtue of the use of a strong getter for water and other impurities and as a result allowing the mercury content in the lamp to be reduced. Influences on the luminous efficiency and the maintenance factor of the lamp by means of coating with getter materials can be avoided by virtue of the fact that the getter(s) (for example the desiccant(s)) is or are not introduced in the form of a coating (for example in the phosphor layer).

A further aspect of the disclosure can be considered that of introducing the getter material(s) (for example desiccant(s)) into the lamp in anhydrous form. In this way, it is possible for the getter material (for example desiccant) to have its full effectiveness and therefore for it to be able to effectively reduce or eliminate impurities in the lamp atmosphere, in contrast to a getter material which is introduced in the form of a coating which only needs to be activated by desiccation and heating.

In accordance with various embodiments, the introduction of the getter material(s) (for example the desiccant(s)) into the discharge vessel can be performed by introducing a receiving container which contains the getter material(s) into the discharge vessel.

The rerelease of water bonded in the getter during the lamp operation can be avoided, in accordance with various embodiments, by virtue of the fact that the getter material(s) are present in the discharge vessel in such a way that they are protected from UV light and/or from ion bombardment (for example in a UV-impermeable glass ampoule, ceramic ampoule, glass ampoule with metal crucible, or metal capsule or other suitable receiving containers which protect against UV radiation introduced into the discharge vessel).

In accordance with various embodiments, the introduction of the getter(s) into the discharge vessel can be performed by means of a receiving container such as, for example, an ampoule. By introducing the getter by means of an ampoule, it is possible to ensure that full getter capacity is available. By being admixed to the (phosphor) coating, however, the getter would come into contact with the atmosphere and would be wholly or partially saturated with water or dissolved in the water.

In accordance with various embodiments, getter substances, in particular desiccants, which differ from the pyroborates and magnesium oxide in that they have a greater desiccation effect are used. In particular, phosphorous pentoxide (P₂O₅), magnesium perchlorate (Mg(ClO₄)₂, calcium sulfate (CaSO₄), calcium chloride (CaCl₂), magnesium chloride (MgCl₂), calcium oxide (CaO), silica gel (SiO₂), various molecular sieves or aluminum oxide (Al₂O₃) (also highly disperse aluminum oxide such as, for example, Alu C) or mixtures of these substances can be introduced into the lamp or into the discharge vessel of the lamp (for example lamp bulb) in anhydrous form. The expression “in anhydrous form” can in this case be understood to mean that the composition of the respective desiccant (for example phosphorus pentoxide) corresponds to the abovementioned chemical formula (i.e. P₂O₅ in the case of phosphorus pentoxide) and the number of superficially adsorbed water molecules is equal to zero or minimal.

The introduction of the getter substances can be performed prior to or after the coating process with phosphor. In other words, the introduction of the getter substances into the discharge vessel of the lamp can be performed before or after a phosphor coating in the context of a phosphor coating process is applied onto or over the inner side of the discharge vessel.

In this context, it should be noted that the term “coating process with phosphor” or “phosphor coating process” as used herein does not necessarily only include the application of the actual phosphor or the actual phosphor layer or phosphor layers, but can possibly also include the application of additional layers prior to the application of the phosphor layer (i.e. clearly layers which are arranged between the inner wall of the discharge vessel and the phosphor layer) and/or the application of additional layers after the application of the phosphor layer.

In accordance with various embodiments, the getter material(s) (for example desiccant) is/are not introduced in the form of a coating.

In accordance with various embodiments, one or more ampoules (for example glass ampoules or ceramic ampoules) are used for the introduction of the getter material(s). When ampoules are used, said ampoules can be fastened on an electrode frame or on two opposite electrode frames of the lamp, for example (in the case of a lamp with electrodes). It is also possible to fix the ampoules already prior to the coating process on the lamp bulb. This can take place by heating to above the transformation temperature and direct adhesive bonding of the glass surfaces of the lamp bulb and the ampoule to one another or else with the aid of a glass solder which acts as bonding agent.

In accordance with various embodiments, a plurality of ampoules can be fixed in the lamp (or in the discharge vessel of the lamp) in a manner physically separated from one another. In this case, a plurality of getter materials (for example desiccants) can be used simultaneously, even if they are not miscible with one another, without said getter materials losing their effectiveness, such as, for example, calcium oxide (CaO) and phosphorous pentoxide (P₂O₅). In this way, it is possible, for example, to use substances such as, for example, CaO and P₂O₅ in combination which, in addition to their desiccation effect, have special getter properties, firstly for acids, such as, for example, carbon dioxide (CO₂), and secondly for bases, such as, for example, ammonia (NH₃), wherein in the mentioned example, CaO acts as an acid getter and P₂O₅ acts as a base getter.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a gas discharge lamp in accordance with one embodiment;

FIG. 2 shows a gas discharge lamp in accordance with a further embodiment;

FIG. 3 shows a gas discharge lamp in accordance with a further embodiment;

FIG. 4 shows a gas discharge lamp in accordance with a further embodiment;

FIG. 5 shows a receiving container for use in a gas discharge lamp in accordance with a further embodiment;

FIG. 6 shows a receiving container for use in a gas discharge lamp in accordance with a further embodiment;

FIG. 7 shows a method for producing a gas discharge lamp in accordance with a further embodiment; and

FIG. 8 shows a flowchart illustrating an exemplary process flow in a method for producing a gas discharge lamp in accordance with a further embodiment.

### DETAILED DESCRIPTION

The following detailed description refers to the accompanying drawing that show, by way of illustration, specific details and embodiments in which the disclosure may be practiced.

In the context of this description, the terms “connected” and “coupled” are used to describe both a direct and an indirect connection and a direct or indirect coupling.

In the figures, identical or similar elements have been provided with identical reference symbols in so far as this is expedient.

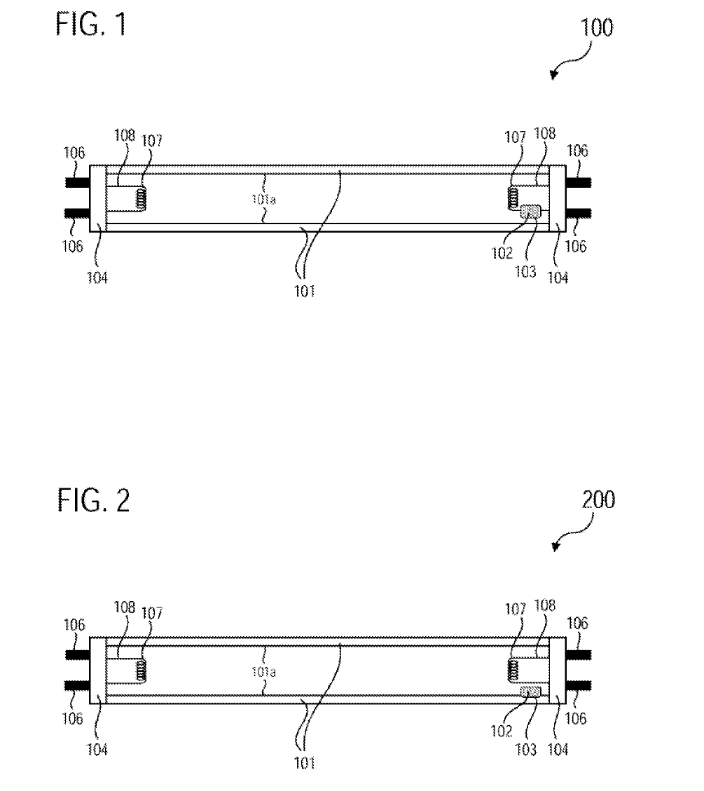

FIG. 1 shows a gas discharge lamp 100 in accordance with one embodiment in the form of a schematic cross-sectional drawing.

The gas discharge lamp 100 is in the form of a tubular lamp and has a discharge vessel 101 which is in the form of a tubular lamp bulb.

A phosphor coating 101a which is used to convert UV radiation generated during the discharge process into visible light is applied to the inner side (in other words the inner wall) of the discharge vessel 101.

The gas discharge lamp 100 has, at each of the two ends of the discharge vessel 101, a base 104 with electrical contacts 106. In each case one electrode 107 with an associated electrode frame 108 (also referred to as electrode holder) is connected to in each case the respective base 104.

In addition, the gas discharge lamp 100 has a receiving container 103, which contains getter material 102 in anhydrous form. The getter material 102 may include or be, for example, one or more (for example different) desiccants and may include, for example, one or more of the materials described herein. In the case of a plurality of (for example different) getter materials in the receiving container 103, the individual getter materials can be contained in separate chambers of the receiving container, for example, with the result that the getter materials do not come into contact with one another.

The receiving container 103 and therefore the getter material 102 contained therein are arranged within the discharge vessel 101. In accordance with the embodiment shown, the receiving container 103 is fitted to one of the two electrode frames (electrode holders) 108 in the discharge vessel 101. In accordance with alternative configurations, in each case one receiving container can be fitted to each of the two electrode frames 108 and/or two or more receiving containers can be fitted to one or both of the electrode frames 108 (not shown).

The receiving container 103 can be in the form of, for example, an ampoule, for example a glass ampoule or ceramic ampoule, for example an ampoule consisting of a UV-absorbing glass in accordance with one configuration. Alternatively, the receiving container 103 may include, for example, a glass ampoule with a crucible (for example metal crucible) located therein, wherein the getter material can be contained in the crucible. In accordance with yet another alternative configuration, the receiving container can be in the form of a metal capsule, for example.

The receiving container 103 can be designed in such a way that it can have been introduced into the discharge vessel 101 of the gas discharge lamp 100 in a closed state (in other words a state in which the getter material 102 contained in the receiving container does not come into contact with the atmosphere prevailing outside the receiving container 103) and can be opened after the introduction (for example after sealing of the discharge vessel 101), with the result that the getter material 102 comes into contact with the lamp atmosphere (i.e. for example with the atmosphere prevailing in the discharge vessel 101 after sealing).

By virtue of the introduction of the receiving container 103 in the still closed state, it is possible to avoid, for example, a situation in which the getter material 102 contained therein comes into contact prematurely with the ambient atmosphere and is possibly wholly or partially saturated with atmospheric impurities (in particular water), as already described previously in this document.

The receiving container 103 can be designed in such a way that it protects the getter material 102 contained therein from UV radiation which is generated by the gas discharge process during operation of the lamp. This makes it possible, for example, to avoid the getter material decomposing as a result of photo dissociation and bonded impurities (for example water) being released again, as has already been described previously in this document.

FIG. 2 shows a gas discharge lamp 200 in accordance with a further embodiment.

The gas discharge lamp 200 in accordance with the embodiment shown in FIG. 2 differs from the gas discharge lamp 100 in accordance with the embodiment shown in FIG. 1 in that the receiving container 103 with the getter material 102 contained therein is not fastened to an electrode frame 108 of the lamp 200 but to the inner side of the discharge vessel 101. The receiving container 103 can be permanently connected to the discharge vessel 101 or the inner-side coating 101a of the discharge vessel 101. For example, in the case of a receiving container 103 in the form of a glass ampoule, the receiving container 103, i.e. the glass ampoule, can be adhesively bonded to the discharge vessel 101, for example directly by means of fusing the ampoule to the inner side of the discharge vessel 101 or by means of a glass solder acting as bonding agent.

In accordance with one configuration, in addition to the receiving container 103 shown in FIG. 2, further receiving containers can be arranged on or fastened to the inner side of the discharge vessel 101 (not shown).

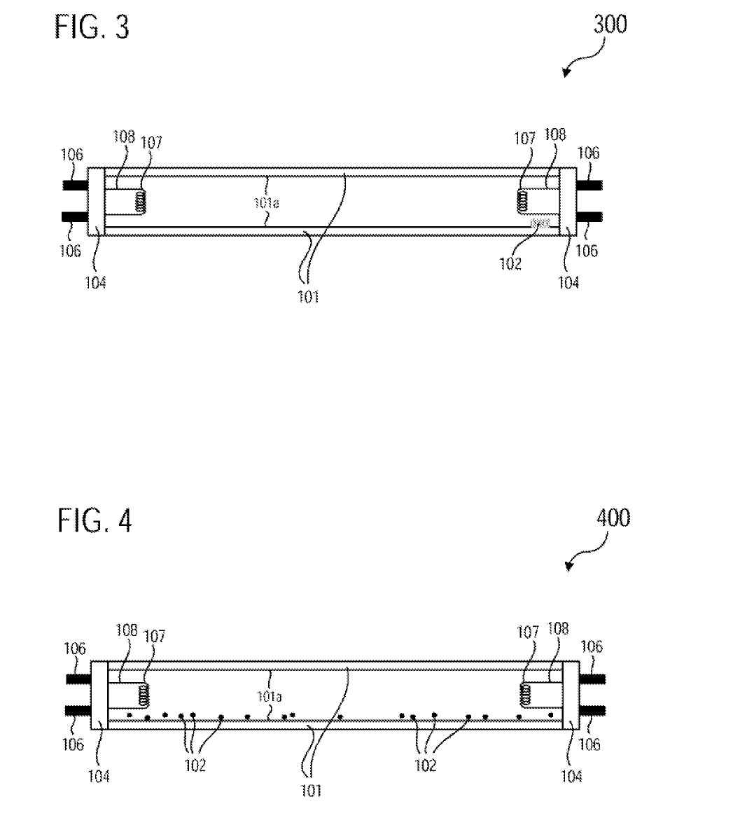

FIG. 3 shows a gas discharge lamp 300 in accordance with a further embodiment.

The gas discharge lamp 300 in accordance with the embodiment shown in FIG. 3 differs from the gas discharge lamp 200 in accordance with the embodiment shown in FIG. 2 in that the getter material 102 has been introduced into the discharge vessel 101 directly, i.e. without being contained in a receiving container 103. In accordance with the embodiment shown in FIG. 3, the getter material 102 is arranged on the inner side of the discharge vessel 101 in the form of an exposed powder tablet. In accordance with alternative configurations, more than one powder tablet can be contained in the discharge vessel 101 (not shown).

FIG. 4 shows a gas discharge lamp 400 in accordance with a further embodiment.

The gas discharge lamp 400 in accordance with the embodiment shown in FIG. 4 differs from the gas discharge lamp 300 in accordance with the embodiment shown in FIG. 3 in that the getter material 102 has been introduced into the discharge vessel 101 in the form of regularly shaped bodies. The bodies or particles can be, for example, pressed bodies, sintered bodies or melt reguli, in accordance with one configuration. The individual particles of the getter material 102 can have, for example, a size (for example diameter) in the range of from approximately 1 mm to approximately 2 mm, in accordance with one configuration. In accordance with a further configuration, the particles can have been introduced into the discharge vessel 101 prior to a pumping process, for example. The particles or bodies (for example pressed bodies, sintered bodies or melt reguli) can be freely movable in the discharge vessel 101.

It should be noted that the illustrations of a tubular lamp with electrodes shown in FIG. 1 to FIG. 4 are only by way of example and, in accordance with alternative embodiments, a gas discharge lamp or a discharge vessel with any desired other form can be used and/or the lamp can be in the form of an electrode-less lamp.

It should furthermore be noted that embodiments and configurations described in connection with FIG. 1 to FIG. 4 can also be combined with one another and in addition also with further embodiments and configurations described herein.

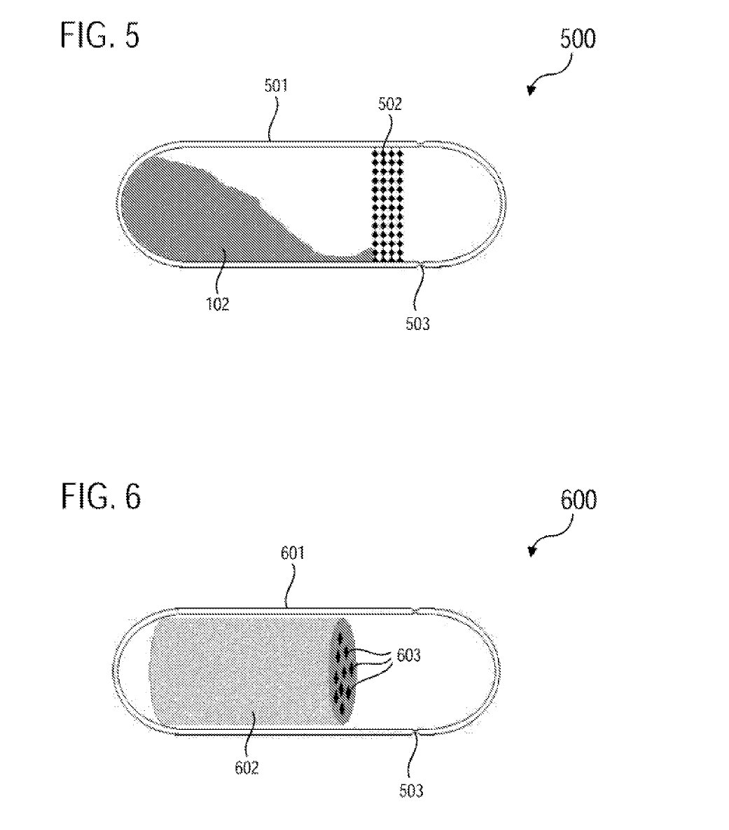

FIG. 5 shows a cross-sectional view of a receiving container 500 for use in a gas discharge lamp in accordance with one embodiment, for example for use in a gas discharge lamp in accordance with one of the embodiments shown in FIG. 1 and FIG. 2 (in other words the receiving container 500 illustrated in FIG. 5 can be used, for example, as the receiving container 103 in the gas discharge lamp 100 in accordance with the embodiment shown in FIG. 1 or in the gas discharge lamp 200 in accordance with the embodiment shown in FIG. 2).

The receiving container 500 has a glass ampoule 501, and getter material 102 is contained in the glass ampoule 501. The glass ampoule 501 is shown in the closed state. The glass ampoule 501 can be introduced with the getter material 102 contained therein in the closed state into the discharge vessel of the gas discharge lamp and opened from outside the discharge vessel, for example once the discharge vessel has been sealed (for example by means of heating or by means of a laser beam). For this, the glass ampoule 501 has a desired breaking point 503, at which the glass ampoule 501 can break open on heating, with the result that the getter material 102 contained in the glass ampoule 501 can come into contact with the lamp atmosphere. In accordance with one configuration, for example, a metal wire (not shown) can be wound around the ampoule 501 at the desired breaking point 503, and this metal wire can be heated by means of an electric direct current or inductively, for example.

In accordance with the embodiment shown, the glass ampoule 501 also has a sintered glass plate 502, which acts as retaining device 501 for retaining the getter material 102 in the glass ampoule 501 once the glass ampoule 501 has been opened. Clearly, the sintered glass plate 502 serves the purpose of preventing the getter material 102 from falling out of the glass ampoule 501. The sintered glass plate 502 has an open-pore structure, wherein the pore size is firstly so small that the getter material 102 cannot pass through the sintered glass plate 502 and is secondly so large that the lamp atmosphere and impurities contained therein can come into contact with the getter material 102 through the sintered glass plate 502.

In accordance with one configuration, the glass ampoule 501 can be formed, for example, from a UV-absorbing glass material in order to prevent the getter material 102 located in the glass ampoule 501 from being decomposed by UV radiation which is produced by the gas discharge process during operation of the lamp.

FIG. 6 shows a cross-sectional view of a receiving container 600 for use in a gas discharge lamp in accordance with a further embodiment, for example for use in a gas discharge lamp in accordance with one of the embodiments shown in FIG. 1 and FIG. 2 (in other words the receiving container 600 illustrated in FIG. 6 can be used, for example, as the receiving container 103 in the gas discharge lamp 100 in accordance with the embodiment shown in FIG. 1 or in the gas discharge lamp 200 in accordance with the embodiment shown in FIG. 2).

The receiving container 600 has an ampoule 601, which can be in the form of a glass ampoule, for example. A metal crucible 602 which contains getter material (not shown) is arranged in the ampoule 601. The metal crucible 602 may include or consist of, for example, one or more of the following metals or an alloy of two or more of the following metals: molybdenum, tungsten, iron, nickel, cobalt, manganese, chromium.

The metal crucible 602 has a plurality of openings 603. The openings 603 are arranged on an end side of the metal crucible 602, which faces one end of the ampoule 601, at which the ampoule 601 can be opened. The openings 603 have such a size that, firstly, the getter material cannot emerge from the metal crucible 602 and, secondly, the getter material can come into contact with the surrounding atmosphere (for example lamp atmosphere) once the ampoule 601 has been opened.

The ampoule 601 is shown in the closed state. The receiving container 600, i.e. the ampoule 601 with the metal crucible 602 located therein and the getter material also located therein, can be introduced into the discharge vessel of the gas discharge lamp in the closed state and can be opened from outside the discharge vessel, for example, once the discharge vessel has been sealed (for example by means of heating or by means of a laser beam). For this purpose, the ampoule 601, similarly to the ampoule 501 shown in FIG. 5, has a desired breaking point 501, at which the ampoule 601 can break open on heating, with the result that the getter material contained in the ampoule 601 (more precisely in the metal crucible 602) can come into contact with the lamp atmosphere.

The metal crucible 602 can serve the purpose of protecting the getter material from the UV radiation produced during operation of the lamp.

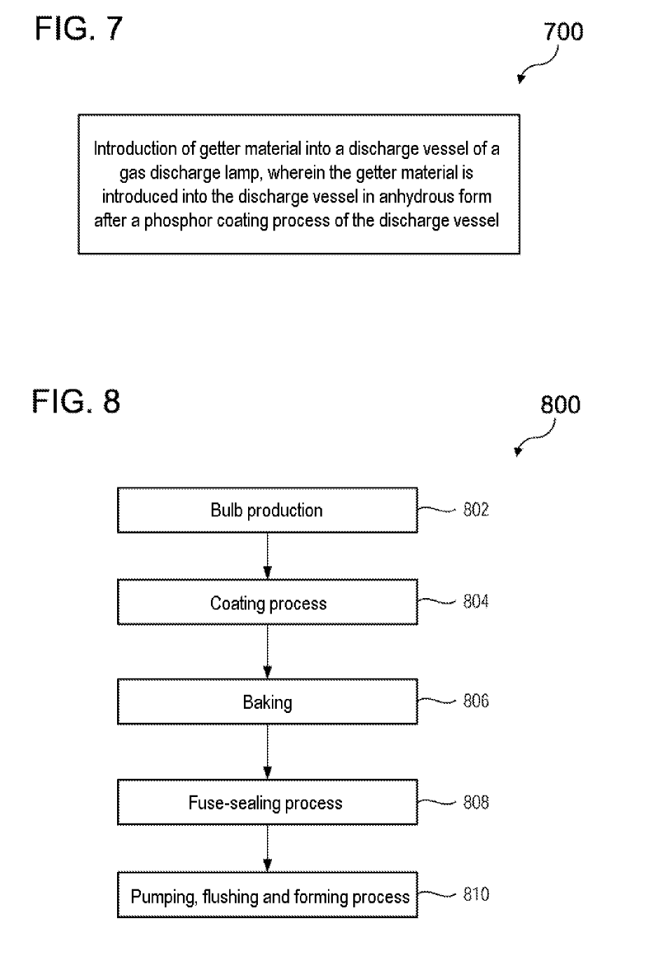

FIG. 7 shows a method 700 for producing a gas discharge lamp in accordance with one embodiment.

In the method, getter material is introduced into a discharge vessel of the gas discharge lamp, wherein the getter material is introduced into the discharge vessel in anhydrous form.

The introduction of the getter material can be performed in accordance with one or more of the embodiments described herein. The getter material may include or consist of one or more of the materials described herein. The discharge vessel can have any desired form.

FIG. 8 shows a graph 800 illustrating an exemplary process flow in a method for producing a gas discharge lamp in accordance with a further embodiment.

In the context of a bulb production process 802, bulbs can be cut from a glass tube and the ends of the bulbs can be tapered and rounded. Then, in accordance with one configuration, one or more receiving containers (for example one or more ampoules, for example one or more glass ampoules) with getter material contained therein can be fitted to the inner bulb surface. The receiving container(s) (for example the ampoule(s)) can be closed, with the result that the getter material contained therein does not come into contact with the surrounding atmosphere.

In 804, in the context of a coating process in accordance with one configuration, first a lower layer can be produced by means of applying a slurry with a lower layer suspension to the inner bulb surface followed by drying. Then, in accordance with one configuration, a top layer can be produced by means of applying a slurry to the inner bulb surface (or to the lower layer formed thereon) and then drying.

In the context of a baking process 806, the coated bulbs can be baked in a baking furnace, for example at a temperature of approximately 600° C. (alternatively at another suitable temperature).

In the context of a fuse-sealing process 808, in each case one disk with an exhaust tube and an electrode frame can be fused to the bulb ends. In accordance with one configuration, in the process one or more receiving containers (for example one or more ampoules) with getter material can be fastened on one or both electrode frames. The receiving container(s) (for example the ampoule(s)) can be closed, with the result that the getter material contained therein cannot come into contact with the surrounding atmosphere. The introduction of the receiving containers can be performed alternatively or in addition to the introduction of the receiving containers as described in connection with the bulb production 802.

In the context of a pumping, flushing and forming process 810, the air can be pumped out of the lamp (the lamp bulb) and the lamp (or the lamp bulb) can be flushed with a noble gas mixture. In addition, the filaments can be heated electrically and thus formed. In accordance with one configuration, getter material in the form of particles with a size of from approximately 1 mm to approximately 2 mm (for example pressed bodies and/or sintered bodies and/or melt reguli) can then be introduced into the lamp (more precisely into the lamp bulb). The introduction of the getter material in the form of particles can be performed as an alternative or in addition to the introduction of the receiving containers as described in connection with the bulb production 802 and/or that as described in connection with the fuse-sealing process 808. Then, the lamp can be filled with a noble gas mixture. The exhaust tubes can be fused off and the lamp can be sealed in a gas-tight manner thereby.

In the case of one or more receiving containers (for example ampoules) introduced into the lamp with getter material or getter materials contained therein, once the lamp has been sealed in a gas-tight manner, the introduced receiving container(s) (for example the ampoule(s)) can be opened (for example by means of heating or by means of a laser beam), with the result that the getter material comes into contact with the lamp atmosphere.

Further embodiments will be described below.

A gas discharge lamp in accordance with one embodiment has a discharge vessel and getter material in the discharge vessel, wherein the getter material has been introduced into the discharge vessel in anhydrous form.

In accordance with one configuration, the getter material has been introduced into the discharge vessel after a phosphor coating process of the discharge vessel.

In accordance with an alternative configuration, the getter material has been introduced into the discharge vessel prior to a phosphor coating process of the discharge vessel.

In accordance with a further configuration, the gas discharge lamp also has a receiving container, which is arranged in the discharge vessel, wherein the getter material is contained in the receiving container.

In accordance with a further configuration, the receiving container at least partially absorbs UV radiation. The receiving container may include or consist of, for example, one or more materials which at least partially absorb UV radiation.

In accordance with a further configuration, the receiving container has a retaining device, which is designed in such a way that the getter material is retained in the receiving container by means of the retaining device.

In accordance with a further configuration, the receiving container is fastened, for example fused, to the inner side of the discharge vessel.

In accordance with a further configuration, the discharge vessel has an electrode frame, and the receiving container is fastened on the electrode frame.

In accordance with a further configuration, the receiving container includes an ampoule or is in the form of an ampoule.

In accordance with a further configuration, the ampoule is in the form of a glass ampoule or in the form of a ceramic ampoule. In other words, the ampoule may include or consist of a glass material or a ceramic material.

In accordance with a further configuration, the ampoule includes a UV-absorbing glass or consists of such a glass. In other words, the ampoule may include or consist of a glass or glass material which is impermeable or virtually impermeable to UV radiation.

In accordance with a further configuration, the retaining device has a perforated partition wall consisting of glass or ceramic or is in the form of such a perforated partition wall.

In accordance with a further configuration, the retaining device has an open-pore sintered glass plate or is in the form of such an open-pore sintered glass plate.

In accordance with a further configuration, the retaining device has an open-pore foam glass plate or is in the form of such an open-pore foam glass plate.

In accordance with a further configuration, the receiving container also has a crucible, which is arranged in the ampoule (for example glass ampoule), wherein the getter material is contained in the crucible.

In accordance with a further configuration, the crucible has one or more openings which have such a size that the getter material contained in the crucible is retained in the crucible.

In accordance with a further configuration, the crucible is in the form of a metal crucible.

In accordance with a further configuration, the metal crucible includes at least one of or an alloy of at least two of the following metals: molybdenum, tungsten, iron, nickel, cobalt, manganese, chromium. In accordance with one configuration, the metal crucible can consist of one or more of or an alloy of two or more of the abovementioned metals.

In accordance with a further configuration, the getter material includes a first getter material and a second getter material. The first getter material and the second getter material can be the same or different getter materials. The first getter material and the second getter material can be, for example, getter materials which would react chemically with one another on contact, for example with the development of heat, i.e. exothermically.

In accordance with a further configuration, the receiving container has a first chamber and a second chamber, wherein the first getter material is contained in the first chamber, and the second getter material is contained in the second chamber. The first chamber and the second chamber can be designed in such a way as to prevent the first getter material and the second getter material from coming into contact with one another.

In accordance with a further configuration, the gas discharge lamp has a second receiving container, wherein the getter material includes a first getter material and a second getter material, wherein the first getter material is contained in the receiving container and the second getter material is contained in the second receiving container. The first getter material and the second getter material can be the same getter materials or different getter materials. The first getter material and the second getter material can be, for example, getter materials which would react chemically with one another on contact, for example with the development of heat, i.e. exothermically.

In accordance with a further configuration, the getter material has been introduced directly into the discharge vessel in such a way that the getter material can come into contact with the inner side of the discharge vessel. The getter material can be freely moveable within the discharge vessel, for example.

In accordance with a further configuration, the getter material is contained in the discharge vessel in the form of regularly shaped bodies. The bodies may include or be in the form of, for example, pressed bodies and/or sintered bodies and/or melt reguli.

In accordance with a further configuration, the bodies have a size (for example diameter) in the range from approximately 1 mm to approximately 2 mm.

In accordance with a further configuration, the getter material includes a desiccant or is in the form of such a desiccant.

In accordance with a further configuration, the desiccant includes at least one of the following desiccants: phosphorous pentoxide, magnesium perchlorate, calcium sulfate, calcium chloride, magnesium chloride, calcium oxide, silica gel, a molecular sieve, aluminum oxide (for example also highly disperse aluminum oxide such as, for example, Alu C). For example, the desiccant may include one or any desired combination of two or more of the abovementioned desiccants. In accordance with a further configuration, in the case where the desiccant includes two or more desiccants which would react chemically with one another on contact, these desiccants can be separated from one another (for example in two or more separate receiving containers or in one receiving container with two or more chambers).

A method for producing a gas discharge lamp in accordance with one embodiment includes introducing getter material into a discharge vessel of the gas discharge lamp, wherein the getter material is introduced into the discharge vessel in anhydrous form.

In accordance with one configuration, the introduction of the getter material is performed after a phosphor coating process of the discharge vessel.

In accordance with one alternative configuration, the introduction of the getter material is performed prior to a phosphor coating process of the discharge vessel.

In accordance with a further configuration, the introduction of the getter material into the discharge vessel is performed by virtue of the fact that a receiving container which contains the getter material is introduced into the discharge vessel.

In accordance with a further configuration, the receiving container is closed when it is introduced into the discharge vessel. The discharge vessel can be sealed once the receiving container has been introduced into the discharge vessel. The receiving container can be opened once the discharge vessel has been sealed.

In accordance with a further configuration, the receiving container includes an ampoule, which is opened once the discharge vessel has been sealed by means of heating or by means of a laser beam.

In accordance with a further configuration, the discharge vessel is evacuated prior to the discharge vessel being sealed. The discharge vessel can be evacuated, for example, once the closed receiving container has been introduced into the discharge vessel. Alternatively, the discharge vessel can be evacuated prior to the closed receiving container being introduced into the discharge vessel.

In accordance with a further configuration, the introduction of the getter material into the discharge vessel is performed by virtue of the fact that the getter material is introduced directly into the discharge vessel in such a way that the getter material can come into contact with the inner side of the discharge vessel. In other words, it is possible for the getter material to be introduced into the discharge vessel not by means of a receiving container filled with the getter material but directly (in other words without being contained in a separate receiving container).

In accordance with a further configuration, the getter material is introduced into the discharge vessel in the form of regularly shaped bodies (for example pressed and/or sintered bodies and/or melt reguli). In accordance with one configuration, the bodies can have, for example, a size (for example a diameter) in the range of from approximately 1 mm to approximately 2 mm.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A gas discharge lamp, comprising:
a discharge vessel;
getter material in the discharge vessel, wherein the getter material has been introduced into the discharge vessel in anhydrous form.

2. The gas discharge lamp as claimed in claim 1, further comprising:
a receiving container, which is arranged in the discharge vessel, wherein the getter material is contained in the receiving container.

3. The gas discharge lamp as claimed in claim 2,
wherein the receiving container at least partially absorbs UV radiation.

4. The gas discharge lamp as claimed in either of claim 2,
wherein the receiving container has a retaining device, which is designed in such a way that the getter material is retained in the receiving container by means of the retaining device.

5. The gas discharge lamp as claimed in claim 2,
wherein the receiving container has an ampoule.

6. The gas discharge lamp as claimed in claim 5,
wherein the ampoule is in the form of a glass ampoule or ceramic ampoule.

7. The gas discharge lamp as claimed in claim 4,
wherein the retaining device has a perforated partition wall consisting of glass or ceramic and/or an open-pore sintered glass plate and/or an open-pore foam glass plate.

8. The gas discharge lamp as claimed claim 5,
wherein the receiving container also has a crucible, which is arranged in the ampoule, wherein the getter material is contained in the crucible.

9. The gas discharge lamp as claimed in claim 8,
wherein the crucible has one or more openings, which have a size such that the getter material contained in the crucible is retained in the crucible.

10. The gas discharge lamp as claimed in claim 8,
wherein the crucible is in the form of a metal crucible.

11. The gas discharge lamp as claimed in claim 2,
wherein the getter material has a first getter material and a second getter material which is different than the first getter material, wherein the receiving container has a first chamber and a second chamber, wherein the first getter material is contained in the first chamber and the second getter material is contained in the second chamber, wherein the first chamber and the second chamber are designed in such a way that the first getter material and the second getter material are prevented from coming into contact with one another.

12. The gas discharge lamp as claimed in claim 2,
further comprising a second receiving container, wherein the getter material has a first getter material and a second getter material which is different than the first getter material, wherein the first getter material is contained in the receiving container and the second getter material is contained in the second receiving container.

13. (canceled)

14. The gas discharge lamp as claimed in claim 13,
wherein the getter material is contained in the discharge vessel in the form of regularly shaped bodies.

15. The gas discharge lamp as claimed in claim 14,
wherein the getter material is contained in the discharge vessel in the form of pressed bodies and/or sintered bodies and/or melt reguli.

16. (canceled)

17. (canceled)

18. A method for producing a gas discharge lamp, comprising:
introducing getter material into a discharge vessel of the gas discharge lamp, wherein the getter material is introduced into the discharge vessel in anhydrous form.

19. The method as claimed in claim 18,
wherein the introducing the getter material into the discharge vessel is performed after a phosphor coating process of the discharge vessel.

20. The method as claimed in claim 18,
wherein the introducing the getter material into the discharge vessel is performed in such a way that a receiving container which contains the getter material is introduced into the discharge vessel.

21. The method as claimed in claim 20,
wherein the receiving container is closed as it is introduced into the discharge vessel, and wherein the method further comprises:
sealing the discharge vessel once the receiving container has been introduced into the discharge vessel; and
opening the receiving container once the discharge vessel has been sealed.

22. The method as claimed in claim 21,
wherein the receiving container comprises an ampoule, which is opened by means of heating or by means of a laser beam once the discharge vessel has been sealed.

23. (canceled)

24. The method as claimed in claim 18,
wherein the getter material is introduced into the discharge vessel in the form of regularly shaped bodies.

25. The method as claimed in claim 24,
wherein the getter material is introduced into the discharge vessel in the form of pressed bodies and/or sintered bodies and/or melt reguli.
